(19) United States
(12) Patent Application Publication
(10) Pub. No.: US 2011/0241235 A1
(43) Pub. Date: Oct. 6, 2011

(54) PROCESS FOR PREPARING SPRAY-DRIED PARTICLES

(76) Inventors: Rohan Govind Murkunde, Morpeth (GB); Paul Andrzej Luksza, Upon Tyne (GB); Carlos Arca Quinones, Barcelona (ES)

(21) Appl. No.: 12/888,544

(22) Filed: Sep. 23, 2010

Related U.S. Application Data
(60) Provisional application No. 61/244,967, filed on Sep. 23, 2009.

(51) Int. Cl. B29B 9/00

(52) U.S. Cl. 264/5

(57) ABSTRACT

The present invention relates to a process of making spray-dried detergent particles comprising the steps: (a) contacting magnesium sulphate with sodium salt of ethylenediamine disuccinic acid to form a premix comprising magnesium salt of ethylenediamine disuccinic acid; (b) contacting said premix with an aqueous slurry comprising detersive surfactant, sodium silicate, and optionally polymer; and (c) spray drying said aqueous slurry to form said spray-dried detergent particles.

### CROSS REFERENCE TO RELATED APPLICATIONS

This application claims priority under 35 U.S.C. §119(e) to U.S. Provisional Application Ser. No. 61/244,967, filed Sep. 23, 2009.

### FIELD OF THE INVENTION

The present invention relates to a process for preparing spray-dried detergent particles. The spray-dried detergent particles have good dissolution profiles and good cleaning profiles.

### BACKGROUND OF THE INVENTION

There is a consumer trend towards lower wash temperatures and, consequently, there is a need to provide highly water-soluble solid particulate laundry detergent compositions. There remains a need to provide a solid particulate laundry detergent composition that has a good dissolution profile. Recent attempts to improve the dissolution profile of solid particulate laundry detergent compositions include reducing the level of, or even removing, zeolite builders from the detergent formulation. In addition, reducing the level of, or even removing phosphate builders improves the environmental profile of the laundry detergent composition.

Sodium silicate is a very beneficial salt to incorporate into solid particulate laundry detergent compositions. The sodium silicate improves the processability of the solid particulate laundry detergent composition, improving the physical profile of the particles, making them crisp and flowability and provides overall good particle characteristics. The sodium silicate also provides alkalinity to the wash liquor, helping solubilize soils and improving the cleaning profile of the laundry detergent composition.

It is also beneficial to incorporate ethylene diamine-N′N′-disuccinic acid into the solid particulate laundry detergent composition. Ethylene diamine-N′N′-disuccinic acid is a chelant, which complexes with cations, protects bleach from unwanted degradation, and improves the cleaning profile of the detergent composition, especially improving the beverage stain cleaning profile.

Magnesium sulphate can be a beneficial material to incorporate into a laundry detergent. The magnesium sulphate provides a source of magnesium cations, which help the micelle kinetics of the detersive surfactant system in the wash liquor, and improves the cleaning performance of the detergent composition. Without wishing to be bound by theory, the Inventors believe that the magnesium cations help pack the detersive surfactant molecules in the micelle at the interface with the soil so as to improve the soil removal mechanism, thus improving the cleaning performance of the laundry detergent composition.

The preferred route for incorporating materials into solid particulate laundry detergent compositions is by a process of spray-drying a slurry comprising the desired laundry detergent ingredients to form a plurality of spray-dried particles. However, the Inventors have found that when sodium silicate, ethylene diamine-N′N′-disuccinic acid and magnesium sulphate are all spray-dried, the resultant plurality of spray-dried particles and resultant solid particulate laundry detergent composition formulated therefrom has very a poor residue profile. This has been especially found when the spray-dried particles comprise very low levels of, or no, zeolite builder and phosphate builder.

The Inventors have overcome this problem by pre-complexing a magnesium sulphate with a sodium salt of ethylenediamine disuccinic acid so as to form a premix comprising magnesium salt of ethylenediamine disuccinic acid. The premix can then be contacted with the aqueous detergent slurry, and then spray-dried to form spray-dried detergent particles. The resultant spray-dried particles have excellent residue profiles, and good cleaning profiles.

### SUMMARY OF THE INVENTION

The present invention provides a process as defined by the claims.

### DETAILED DESCRIPTION OF THE INVENTION

### Process of Making a Spray-Dried Detergent Particles

The process comprises the steps: (a) contacting magnesium sulphate with sodium salt of ethylenediamine disuccinic acid to form a premix comprising magnesium salt of ethylenediamine disuccinic acid; (b) contacting said premix with an aqueous slurry comprising detersive surfactant, sodium silicate, and optionally polymer; and (c) spray drying said aqueous slurry to form said spray-dried detergent particles.

Typically, step (a) is carried out before the magnesium sulphate is contacted to sodium silicate. In this manner, the contact between the magnesium sulphate and sodium silicate is minimized, preferably avoided. Without wishing to be bound by theory, the inventors believe that contact of the magnesium sulphate with sodium silicate prior to forming the pre-mix, results in unwanted cation exchange leading to the unwanted formation of magnesium silicate, which in turn reduces the residue profile of the laundry detergent composition. The pre-mixing of the magnesium sulphate with the sodium salt of ethylenediamine disuccinic acid, and the subsequent formation of the pre-mix comprising magnesium salt of ethylenediamine disuccinic acid, reduces the formation of magnesium silicate when the detergent ingredients are introduced into the aqueous slurry. Preferably, the molar ratio (i) the sodium salt of ethylenediamine disuccinic acid to (ii) magnesium sulphate is at least 1:1, preferably greater than 1:1, preferably at least 1.2:1, or even at least 2:1, or even at least 4:1.

The aqueous slurry can be spray-dried by any conventional spray-drying technique. Typically, the spray-drying process comprises the steps of: (i) spraying the aqueous slurry into a spray-drying zone, preferably wherein the air inlet air temperature into the spray-drying zone is greater than 150° C.; and (ii) drying the aqueous slurry to form a spray-dried powder.

The in-let air temperature into the spray-drying zone is preferably in the range of from greater than 150° C. to 500° C., preferably from 200° C., or from 250° C., and preferably to 450° C. or even to 400° C. The out-let (exhaust) air temperature is typically in the range of from 50° C. to 150° C., preferably from 60° C., or 70° C. or even 80° C., and preferably to 140° C., or to 130° C., or to 120° C., or to 110° C., or even to 100° C.

The temperature of the spray-dried powder exiting the spray-drying tower is typically in the range of from 50° C. to 150° C., preferably from 60° C., or even from 70° C., and preferably to 140° C., or to 130° C., or to 120° C., or to 110° C., or even to 100° C. Preferably the spray-dried powder exiting the spray-drying tower has a temperature of less than 150° C., preferably less than 140° C., or less than 130° C., or less than 120° C., or less than 110° C., and preferably less than to 100° C.

The spray-dried powder typically exits the spray-drying zone (e.g. falls from the spray-drying tower) onto a conveyor belt, where other ingredients (such as percarbonate particles) are dry-added to the powder to form a laundry detergent composition.

### Spray-Dried Detergent Particles

The spray-dried detergent particles is preferably a plurality of spray-dried laundry detergent particles.

The presence of magnesium silicate in the spray-dried detergent particles is unwanted. Preferably said spray-dried detergent particles comprise less than about 1 wt % of magnesium silicate, preferably said spray-dried detergent particles comprise less than about 0.5 wt %, or less than about 0.2 wt %, or even less than 0.1 wt % magnesium silicate. However, if the spray-dried detergent particles do comprise magnesium silicate, then preferably said spray-dried detergent particles comprise magnesium salt of ethylenediamine disuccinic acid and magnesium silicate in the weight ratio of (i) magnesium salt of ethylenediamine disuccinic acid to (ii) magnesium silicate of at least 10:1, preferably at least 20:1, or at least 50:1, or even at least 100:1.

The spray-detergent particles may comprise an additional chelant. Said spray-dried detergent particles may further comprise hydroxyethane diphosphonic acid. Said spray-dried detergent particles may comprise 4,5-dihydroxy-m-benzenedisulfonic acid disodium salt.

Said spray-dried detergent particles preferably comprise: (a) from 0 wt % to 10 wt % zeolite builder; and (b) from 0 wt % to 10 wt % phosphate builder. Said zeolite builder and said phosphate builder are described in more detail below.

Said spray-dried detergent particles typically comprise optional detergent ingredients. Said optional detergent ingredients are described in more detail below,

### Aqueous Slurry

Said aqueous slurry comprises detersive surfactant, sodium silicate, and optionally polymer. Preferably, said aqueous slurry comprises carboxylate polymer.

Preferably, said aqueous slurry is alkaline. Preferably, said aqueous slurry further comprises an alkalinity source selected from the group of: carbonate salt; sodium hydroxide; and mixtures thereof.

Typically, the aqueous slurry comprises (a) anionic detersive surfactant; (b) from 0 wt % to 20 wt % zeolite builder; (c) from 0 wt % to 20 wt % phosphate builder; (d) from 1 wt % to 20 wt % silicate salt; (e) optionally carbonate salt; (f) optionally polymeric material; and (g) water. The aqueous slurry may comprise other detergent ingredients.

Preferably, the aqueous slurry comprises less than 15 wt %, or less than 10 wt %, or even less than 5 wt % zeolite builder. Preferably the aqueous slurry is essentially free of zeolite builder. By essentially free it is typically meant herein as meaning no deliberately added.

Preferably, the aqueous slurry comprises less than 15 wt %, or less than 10 wt %, or even less than 5 wt % phosphate builder. Preferably the aqueous slurry is essentially free of phosphate builder. By essentially free it is typically meant herein as meaning no deliberately added.

### Ethylenediamine Disuccinic Acid

Preferably, the ethylenediamine disuccinic acid is in its S′S′ enantiomeric form.

### Detersive Surfactant

Suitable detersive surfactants include anionic, cationic, non-ionic, zwitterionic detersive surfactants, amphoteric detersive surfactants, and mixtures thereof.

Suitable detersive surfactants include a combination of alkyl benzene sulphonate and one or more detersive co-surfactants. The detersive surfactant preferably comprises C₁₀-C₁₃ alkyl benzene sulphonate and one or more detersive co-surfactants. The detersive co-surfactants are preferably selected from the group consisting of C₁₂-C₁₈ alkyl ethoxylated alcohols, preferably having an average degree of ethoxylation of from 1 to 7; C₁₂-C₁₈ alkyl ethoxylated sulphates, preferably having an average degree of ethoxylation of from 1 to 5; and mixtures thereof. However, other surfactant systems may be suitable for use in the present invention.

Suitable anionic detersive surfactants include: alkyl sulphates; alkyl sulphonates; alkyl phosphates; alkyl phosphonates; alkyl carboxylates; and mixtures thereof. The anionic surfactant can be selected from the group consisting of: C₁₀-C₁₈ alkyl benzene sulphonates (LAS) preferably C₁₀-C₁₃ alkyl benzene sulphonates; C₁₀-C₂₀ primary, branched chain, linear-chain and random-chain alkyl sulphates (AS), typically having the following formula:

CH₃(CH₂)xCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

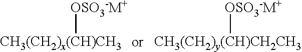

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants include: linear or branched, substituted or unsubstituted alkyl benzene sulphonate detersive surfactants, preferably linear C₈-C₁₈ alkyl benzene sulphonate detersive surfactants; linear or branched, substituted or unsubstituted alkyl benzene sulphate detersive surfactants; linear or branched, substituted or unsubstituted alkyl sulphate detersive surfactants, including linear C₈-C₁₈ alkyl sulphate detersive surfactants, C₁-C₃ alkyl branched C₈-C₁₈ alkyl sulphate detersive surfactants, linear or branched alkoxylated C₈-C₁₈ alkyl sulphate detersive surfactants and mixtures thereof; linear or branched, substituted or unsubstituted alkyl sulphonate detersive surfactants; and mixtures thereof.

Preferred alkoxylated alkyl sulphate detersive surfactants are linear or branched, substituted or unsubstituted C₈₋₁₈ alkyl alkoxylated sulphate detersive surfactants having an average degree of alkoxylation of from 1 to 30, preferably from 1 to 10. Preferably, the alkoxylated alkyl sulphate detersive surfactant is a linear or branched, substituted or unsubstituted C₈₋₁₈ alkyl ethoxylated sulphate having an average degree of ethoxylation of from 1 to 10. Most preferably, the alkoxylated alkyl sulphate detersive surfactant is a linear unsubstituted C₈₋₁₈ alkyl ethoxylated sulphate having an average degree of ethoxylation of from 3 to 7. Preferably, the laundry detergent composition comprises an alkyl ethoxylated sulphate having an average degree of ethoxylation of from 0.5 to 3.5, preferably from 1.0 to 3.0, and preferably 1.0 or 3.0.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. Preferably, the laundry detergent composition comprises a predominantly C₁₂ alkyl sulphate.

Suitable cationic detersive surfactants include: alkyl pyridinium compounds; alkyl quaternary ammonium compounds; alkyl quaternary phosphonium compounds; alkyl ternary sulphonium compounds; and mixtures thereof. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable non-ionic detersive surfactant can be selected from the group consisting of: C₈-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 10, more preferably from 3 to 7.

Preferably, said detersive surfactant is selected from the group of: alkyl benzene sulfonate; alkoxylated alkyl sulphate; alkyl sulphate; alkoxylated alcohol; and mixtures thereof.

### Polymer

A preferred polymer is a carboxylate polymer, described in more detail below. Another suitable polymer is a cellulosic based polymer such as methyl cellulose, carboxymethyl cellulose, methyl hydroxyethyl cellulose, and combinations thereof.

Another suitable polymer is an amphilic graft co-polymer, preferably the amphilic graft co-polymer comprises (i) polyethyelene glycol backbone; and (ii) and at least one pendant moiety selected from polyvinyl acetate, polyvinyl alcohol and mixtures thereof. A preferred amphilic graft co-polymer is Sokalan HP22, supplied from BASF.

### Carboxylate Polymer

Suitable carboxylate polymers include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

### Additional Chelants

The spray-dried detergent particles may comprise chelants in addition to the ethylene diamine-N′N′-disuccinic acid. Suitable additional chelants include diethylene triamine pentaacetate, diethylene triamine penta(methyl phosphonic acid), ethylene diamine tetraacetate, ethylene diamine tetra(methylene phosphonic acid) and hydroxyethane di(methylene phosphonic acid). A preferred additional chelant is hydroxyethane diphosphonic acid (HEDP). Another preferred additional chelant is 4,5-dihydroxy-m-benzenedisulfonic acid disodium salt.

### Alkalinity Source

Suitable alkalinity source are selected from the group of: carbonate salt; sodium hydroxide; and mixtures thereof.

### Zeolite Builder

Preferably, the spray-dried detergent particles comprise from 0 wt % to 10 wt % zeolite builder, preferably to 8 wt %, or to 6 wt %, or to 4 wt %, or even to 2 wt % zeolite builder. The spray-dried detergent particles may even be substantially free of zeolite builder, substantially free means “no deliberately added”. Typical zeolite builders are zeolite A, zeolite P and zeolite MAP.

### Phosphate Builder

Preferably, the spray-dried detergent particles comprise from 0 wt % to 10 wt % phosphate builder, preferably to 8 wt %, or to 6 wt %, or to 4 wt %, or even to 2 wt % phosphate builder. The spray-dried detergent particles may even be substantially free of phosphate builder, substantially free means “no deliberately added”. A typical phosphate builder is sodium tri-polyphosphate.

### Optional Detergent Ingredients

The spray-dried detergent particles typically comprise other detergent ingredients. Suitable optional detergent ingredients include: bleach; sources of hydrogen peroxide such as percarbonate and perborate, especially coated percarbonate; bleach activators preferably tetraacetylthylene diamine (TAED) and oxybenzene sulphonate (OBS); bleach boosters such as imine bleach boosters, and especially oxaziridinium bleach boosters; pre-formed peracids; transition metal catalysts; enzymes such as amylases, carbohydrases, cellulases, laccases, lipases, bleaching enzymes such as oxidases and peroxidases, proteases, pectate lyases and mannanases; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; perfumes such as perfume microcapsules; soap rings; aesthetic particles; dyes; fillers such as sodium sulphate, although it is preferred for the composition to be substantially free of fillers; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose; and any combination thereof.

### EXAMPLE

### Example 1

### A Process for Making Spray-Dried Laundry Detergent Powder

### Aqueous Slurry Composition

| | % w/w |
|---|---|
| | Aqueous |
| Component | slurry |
| Pre-mix comprising magnesium salt of ethylenediamine | 6.8 |
| disuccinic acid* | |
| Linear alkyl benzene sulphonate | 10.6 |
| Sodium silicate | 2.0 |
| Acrylate/maleate copolymer | 4.6 |
| Sodium carbonate | 19.4 |
| Sodium sulphate | 26.6 |
| Water | 29.0 |
| Miscellaneous, such as brightener, and one or more stabilizers | 1.0 |
| Total Parts | 100.00 |

### Example 2

### A Process for Making Spray-Dried Laundry Detergent Powder

### Aqueous Slurry Composition

| | % w/w |
|---|---|
| | Aqueous |
| Component | slurry |
| Pre-mix comprising magnesium salt of ethylenediamine | 6 |
| disuccinic acid* | |
| Linear alkyl benzene sulphonate | 12.4 |
| Sodium silicate | 7 |
| Acrylate/maleate copolymer | 3.3 |
| Sodium carbonate | 11.1 |
| Sodium sulphate | 31 |
| Water | 28.2 |
| Miscellaneous, such as brightener, and one or more stabilizers | 1.0 |
| Total Parts | 100.00 |

### Preparation of a Spray-Dried Laundry Detergent Powder.

*0.32 parts (weight) of sodium salt of ethylenediamine disuccinic acid is mixed with 0.99 parts (weight) of magnesium sulphate and 4.5 parts (weight) of water to form a pre-mix comprising the magnesium salt of ethylenediamine disuccinic acid. The pre-mix is then introduced into the aqueous detergent slurry, the composition of which is given above.

Any ingredient added above in liquid form is heated to 70° C., such that the aqueous slurry is never at a temperature below 70° C. At the end of preparation, the aqueous slurry is heated to 80° C. and pumped under pressure (7.5×10⁶ Nm⁻²), into a counter current spray-drying tower with an air inlet temperature of from between 250° C. to 330° C. The in-let air fan is set such that the tower in-let air-flow is 187,500 kgh⁻¹. The exhaust air fan is controlled to give a negative pressure in the tower of −200 Nm⁻² (typically the out-let air flow rate through the exhaust fan is between 220,000 kgh⁻¹ to 240,000 kgh⁻¹, this includes the evaporated water from the slurry). The aqueous slurry is atomised and the atomised slurry is dried to produce a solid mixture, which is then cooled and sieved to remove oversize material (>1.8 mm) to form a spray-dried powder, which is free-flowing. Fine material (<0.175 mm) is elutriated with the exhaust the exhaust air in the spray-drying tower and collected in a post tower containment system. The spray-dried powder has a moisture content of 2.0 wt %, a bulk density of 400 g/l and a particle size distribution such that greater than 90 wt % of the spray-dried powder has a particle size of from 175 to 710 micrometers. The temperature of the powder exiting the tower has a temperature of below 150° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making spray-dried detergent particles comprising the steps:
(a) contacting magnesium sulphate with sodium salt of ethylenediamine disuccinic acid to form a premix comprising magnesium salt of ethylenediamine disuccinic acid;
(b) contacting said premix with an aqueous slurry comprising detersive surfactant, sodium silicate, and optionally polymer; and
(c) spray-drying said aqueous slurry to form said spray-dried detergent particles.

2. The process of claim 1, wherein said spray-dried detergent particles comprise less than about 1 wt % of magnesium silicate.

3. The process of claim 2, wherein said spray-dried detergent particles comprise magnesium salt of ethylenediamine disuccinic acid and magnesium silicate in the weight ratio of (i) magnesium salt of ethylenediamine disuccinic acid to (ii) magnesium silicate of at least 10:1.

4. The process of claim 1, wherein said detersive surfactant is selected from the group consisting of: alkyl benzene sulfonate; alkoxylated alkyl sulphate; alkyl sulphate; alkoxylated alcohol; and mixtures thereof.

5. The process of claim 1, wherein said aqueous slurry comprises carboxylate polymer.

6. The process of claim 1, wherein said spray-dried detergent particles comprise hydroxyethane diphosphonic acid.

7. The process of claim 1, wherein said spray-dried detergent particles comprise 4,5-dihydroxy-m-benzenedisulfonic acid disodium salt.

8. The process of claim 1, wherein said aqueous slurry comprises an alkalinity source selected from the group of: carbonate salt; sodium hydroxide; and mixtures thereof.

9. The process of claim 1, wherein said spray-dried detergent particles comprise:
(a) from 0 wt % to 10 wt % zeolite builder; and
(b) from 0 wt % to 10 wt % phosphate builder.

10. The process of claim 1, wherein the ethylenediamine disuccinic acid is in its S′S′ enantiomeric form.

11. The process of claim 1, wherein the spray-dried detergent particles are spray-dried laundry detergent particles.
